(19) United States
(12) Patent Application Publication
(10) Pub. No.: US 2019/0057629 A1
(43) Pub. Date: Feb. 21, 2019

(54) Modular banner kit and a method for deploying same

(71) Applicant: TAIT TOWERS MANUFACTURING, LLC, Lititz, PA (US)

(72) Inventor: Tyler Kicera, Manheim, PA (US)

(21) Appl. No.: 15/998,835

(22) Filed: Aug. 16, 2018

Related U.S. Application Data
(60) Provisional application No. 62/546,085, filed on Aug. 16, 2017.

(51) Int. Cl. G09F 17/00; G09F 23/00; G09F 11/08; G09F 19/12

(52) U.S. Cl. CPC G09F 17/00; G09F 23/00; G09F 2017/0041; G09F 19/12; G09F 11/08

(57) ABSTRACT

A modular banner kit is provided having a trainable surface support element, a spindle component configured for training of the trainable surface support element therearound, a targeted illumination feature operable to selectively increase the visibility of the trainable surface support element, and a take-up action module configured to drivingly rotate the spindle component to thereby effect winding of the trainable surface support element onto the spindle component or to effect unwinding of the trainable surface support element from a partially or fully wound-up condition. A method for operating the modular banner kit and an entertainment venue are also provided.

### FIELD OF THE INVENTION

The present invention generally relates to methods and apparatus for storing and deploying banner systems. More specifically, the present invention relates to modular banner kits that are deployable in entertainment venues, the banner kits being able to alternatively retract banners or other suspended display devices into a stored position or deploy banners into a display position.

### BACKGROUND OF THE INVENTION

U.S. Pat. No. 6,688,026 to Clark discloses that protective netting 10 is commonly utilized at sporting venues 16 for protecting spectators 21 from sporting objects thrown or kicked from an athletic field 22. According to U.S. Pat. No. 6,688,026 to Clark, such a protective net is typically suspended by a plurality of cables from the ceiling of an enclosed stadium or, in the alternative, stretched between a plurality of frame structures (not shown) provided for this specific purpose. U.S. Pat. No. 6,688,026 to Clark discloses that such a protective net can be provided with an applique for the display of advertising content. U.S. Pat. No. 6,688,026 is hereby incorporated by reference in its entirety.

It is also known to suspend other types of flexible textile structures from the ceiling of an enclosed stadium including, for example, flexible textile structures often referred to as “banners” or “pennants” which display a commemoration of a championship award that has been awarded to a sports team associated with the stadium.

While it is known to hang flexible textile structures, such as banners or the like, from the ceiling of an enclosed stadium, there is room for improvement in connection with the equipment that supports such banners and in the methods of operating such equipment. Moreover, there is an unmet need to provide a modular banner kit and a method for deploying such a modular banner kit that may offer more flexibility in deploying and storing suspended textile structures, such as, for example, banners of the type that are often displayed in stadiums and other sports or artistic performance environments. Additionally, there is an unmet need to provide a modular banner kit and a method for deploying such a modular banner kit that may offer opportunities for improving the convenience of deploying such banners and, additionally, opportunities for improving the aesthetics of displaying such banners as well as the aesthetics of storing banners in a storage mode.

### BRIEF DESCRIPTION OF THE INVENTION

The present invention relates, in one aspect thereof, to a modular banner kit. The present invention relates, in another aspect thereof, to a method for deploying such a modular banner kit. The method includes providing a modular banner kit having a trainable surface support element, a spindle component configured for training of the trainable surface support element therearound, a take-up action module configured to drivingly rotate the spindle component to thereby effect winding of the trainable surface support element onto the spindle component or to effect unwinding of the trainable surface support element from a partially or fully wound-up condition. The modular banner kit may optionally include a targeted illumination feature. An advantage of the present invention is the ability to provide a banner that can be selectively furled and unfurled from a location well above a floor or a performance surface without the need for an operator to ascend and descend the winding rig onto which the banner is furled.

Another embodiment of the present invention includes a method of deploying a banner. The method includes providing a modular banner kit having a banner, a spindle component configured for training of the banner therearound, a take-up action element configured to drivingly rotate the spindle component to thereby effect winding of the banner onto the spindle component or to effect unwinding of the banner from a partially or fully wound-up condition, and an illumination element operable to emit illumination at least a portion of which is incident upon the banner and the spindle component. The take-up action element is operated to drivingly rotate the spindle component to thereby drivingly raise or lower the banner. The illumination element is operated to emit illumination.

Another embodiment of the present invention includes an entertainment venue. The entertainment venue includes a roof structural component and a plurality of modular banner kits suspended by the roof structural component. Each modular banner kit includes a trainable surface support element, a spindle component configured for training of the trainable surface support element therearound, a targeted illumination feature operable to selectively increase the visibility of the trainable surface support element, and a take-up action module configured to drivingly rotate the spindle component to thereby effect winding of the trainable surface support element onto the spindle component or to effect unwinding of the trainable surface support element from a partially or fully wound-up condition.

An advantage of the present invention is that a capability is provided to selectively vary one or several properties of a suspended banner in a manner that varies the visual characteristics of the banner perceivable by audience members. In this regard, a portion or all of a display surface of a suspended banner can be selectively illuminated to improve the visibility of the display surface. As another example of a variable property for a banner provided by the present invention, a suspended banner can be made to undulate or wave in a prescribed manner, thereby enhancing a visual appeal of the banner.

Further aspects of the present invention are disclosed herein. The features as discussed above, as well as other features and advantages of the present disclosure, will be appreciated and understood by those skilled in the art from the following detailed description and drawings.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a perspective view of a venue in the form of a stadium in which several units of one embodiment of the modular banner kit are deployed;

FIG. 2 is an enlarged top perspective view of the single unit of the modular banner kit shown in isolation in FIG. 1;

FIG. 3 is a schematic perspective view of the spatial reference legend;

FIG. 4 is an enlarged top perspective view of the modular banner kit shown in FIG. 2;

FIG. 5 is an enlarged top perspective view in partial section of the modular banner kit shown in FIG. 2;

FIG. 6 is a front plan view of the modular banner kit of the present invention shown in FIG. 1;

FIG. 7 is a side elevation view of the one embodiment of the modular banner kit of the present invention shown in FIG. 1;

FIG. 8 is a schematic graphical representation of the orientation of the light beam emitted by the modular banner kit relative to the horizontal plane PL-H delimited by the width axis WID-W and the length axis LEN-L;

FIG. 9 is a schematic graphical representation of the orientation of the light beam emitted by the modular banner kit relative to the horizontal plane PL-H delimited by the width axis WID-W and the length axis LEN-L;

FIG. 10 is a schematic graphical representation of the orientation of the light beam emitted by the modular banner kit relative to the horizontal plane PL-H delimited by the width axis WID-W and the length axis LEN-L;

FIG. 11 is a schematic graphical representation of the orientation of the light beam emitted by the modular banner kit relative to the horizontal plane PL-H delimited by the width axis WID-W and the length axis LEN-L;

FIG. 12 is a top perspective view of the one variation of the modular banner kit;

FIG. 13 is a top perspective view of the one variation of the modular banner kit;

FIG. 14 is a top perspective view of the one variation of the modular banner kit shown in FIG. 12 and FIG. 13;

FIG. 15 is an enlarged top perspective view of a portion of the one variation of the modular banner kit shown in FIG. 15;

FIG. 16 is a top perspective view of one variation of the modular banner kit;

FIG. 17 is a top view of the one variation of the modular banner kit;

FIG. 18 is a section view shown of the one variation of the modular banner kit shown in FIG. 17 shown in direction 18-18;

FIG. 19 is a bottom perspective view of one variation of the modular banner kit in the retracted position;

FIG. 20 is a bottom perspective view of the one variation of the modular banner kit of FIG. 19 in the deployed position; and

FIG. 21 is a bottom perspective view of an arrangement of modular banner kits according to an embodiment;

Wherever possible, the same reference numbers will be used throughout the drawings to represent the same parts.

### DETAILED DESCRIPTION OF THE INVENTION

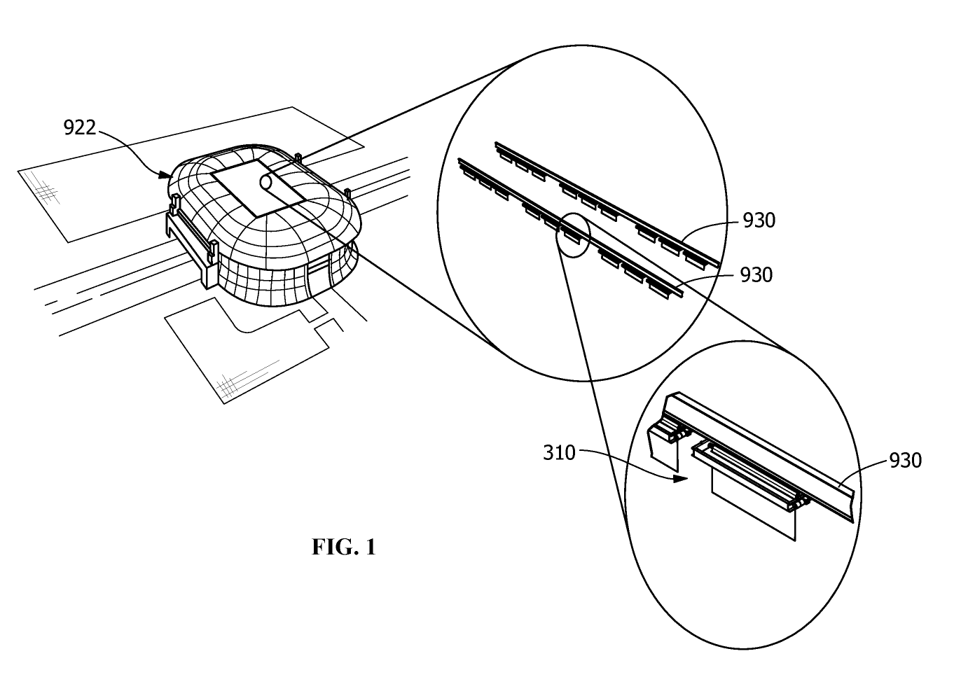

Reference is now had to FIGS. 1-11 for a description of an embodiment of the modular banner kit and an example of one manner of operating the exemplary configuration of the modular banner kit in accordance with the method of the present invention.

FIG. 1 is a perspective view of a venue in the form of an entertainment venue or stadium in which several units of one embodiment of the modular banner kit, hereinafter designated as a modular banner kit 310, are deployed. As seen in FIG. 1, the venue is suitable for live performances and other performances and is representatively shown as a multi-use stadium 922 that is characteristic of the type that provides an all-weather enclosure in which audience seats are arranged around a central performance area. The central performance area may optionally be re-configurable to accommodate a portable stage on which, for example, a music performer can perform live performances or to accommodate a hard surface floor having specific lines and markings for a sports event such as, for example, a hard surface floor providing the lines and markings of a basketball court.

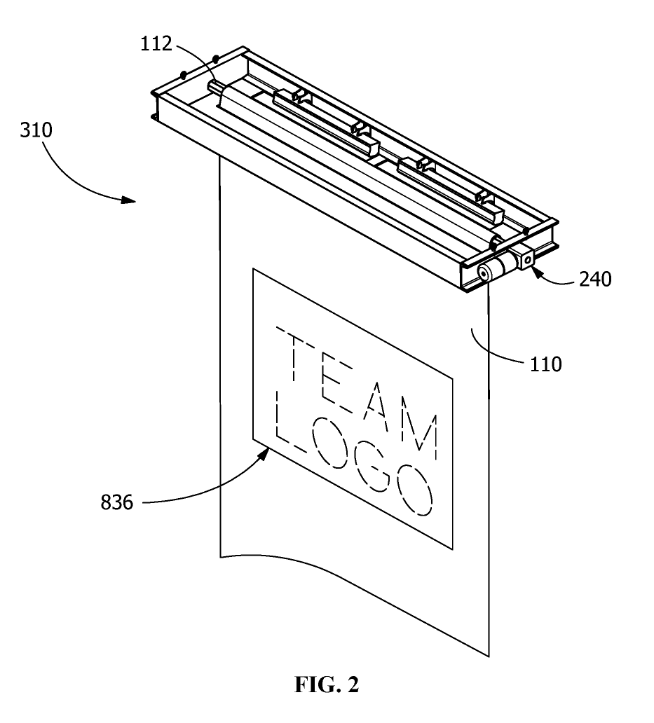

A more detailed description will now be had of a single unit of the modular banner kit 310 shown in FIG. 1, it being understood that the other units of the modular banner kit 310 shown in FIG. 1 are similarly configured. As seen in FIG. 2, which is an enlarged top perspective view of the single unit of the modular banner kit shown in isolation in FIG. 1, modular banner kit 310 comprises a trainable surface support element in the form of a banner 110, a spindle component configured for training of the trainable surface support element therearound in the form of a drum 112, a targeted illumination feature operable to selectively increase the visibility of the banner 110, and a take-up action module 240 configured to drivingly rotate the drum 112 to thereby effect winding of the banner 110 onto the drum 112 into a partially wound-up or fully wound-up condition or to effect unwinding of the banner 110 from a partially wound-up or fully wound-up condition into a relatively less wound-up condition up to and including a fully unwound condition. In one embodiment, trainable surface support element is a banner 110 and may include, but is not limited to, elements, such as a pennant, a jersey, a team or player identifier (e.g., player number or team name), an award, an advertisement, or combination thereof. Such team and play identifiers may, for example, be photographs, images, or trademarks. According to further details of this one aspect of the present invention, the targeted illumination feature is operable to selectively increase the visibility of the trainable surface support element and may comprise, for example, one or a plurality of illumination devices each operable to selectively direct a fall of light onto a deployed trainable surface support element such as, for example, the banner 110 that has been unfurled from the drum 112 to extend downwardly from the drum 112 in a generally planar vertical deployment.

As further seen in FIG. 1, the stadium 922 includes a plurality of roof structural components in the form of a plurality of I-beam girders 930 located interiorly of the roof covering of the stadium and several units of the modular banner kit 310 that are operatively deployed on an I-beam girder 930. Each modular banner kit 310 is operable to selectively furl and unfurl a dedicated banner on which may be displayed, for example, a display commemorating a noteworthy accomplishment of a group associated with the stadium 922, such as, for example, a banner displaying a commemoration of a championship award that has been awarded to a sports team, as is representatively shown in FIG. 2 in the form of an indicia 836 carried on the banner 110.

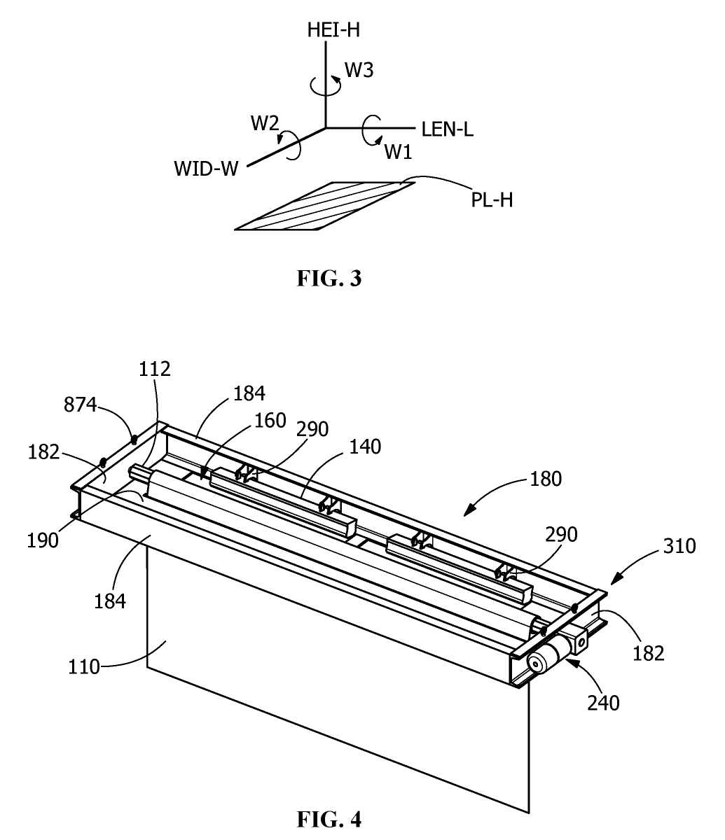

Solely for the purpose of facilitating the description herein of the embodiment of the modular banner kit and its exemplary operation in accordance with the method of the present invention, reference will be had to a spatial reference legend. As seen in FIG. 3, which is a schematic perspective view of the spatial reference legend, the spatial reference legend is comprised of a length axis LEN-L, a width axis WID-W, as measured in a direction perpendicular to its length axis LEN-L, and a height axis HEI-H as measured in a direction perpendicular to its length axis LEN-L and perpendicular to its width axis WID-W. Additionally, in some instances, a component of the modular banner kit 310 may be subjected to movement relative to a rotation axis and, in accordance with the spatial reference legend, such rotational movements may include a rotation movement W1 about an axis parallel to its length axis LEN-L, a rotation movement W2 about an axis parallel to its width axis WID-W, or a rotation movement W3 about an axis parallel to its height axis HEI-H.

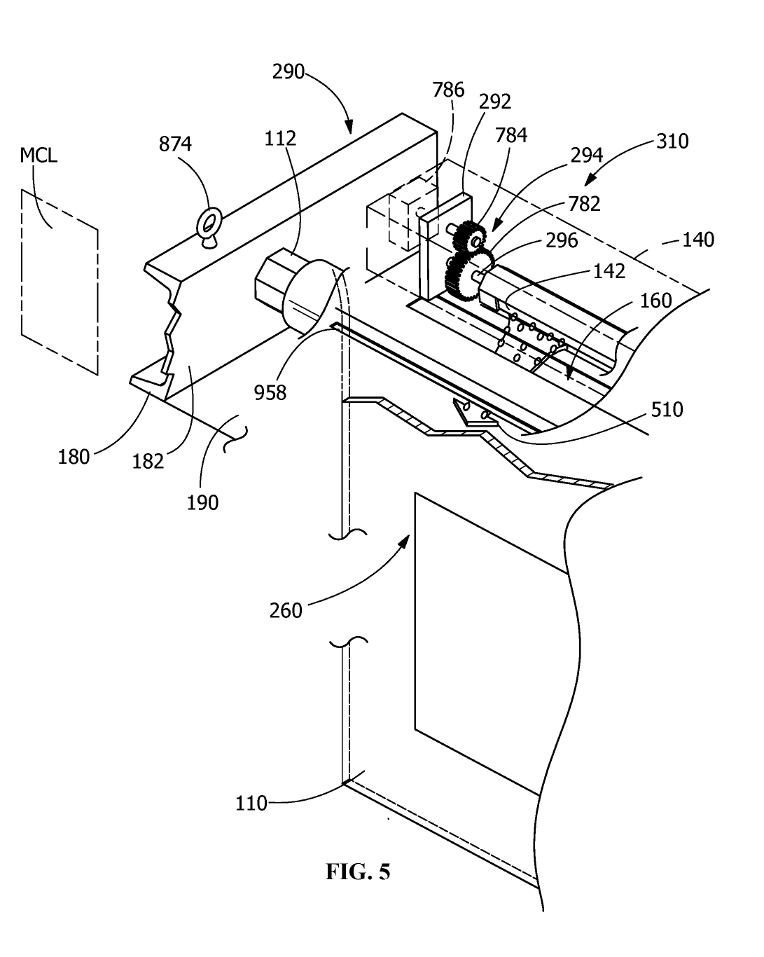

Reference is now had to FIG. 4, which is an enlarged top perspective view of the modular banner kit 310 shown in FIG. 2, and FIG. 5, which is an enlarged top perspective view in partial section of the modular banner kit 310 shown in FIG. 2. The modular banner kit 310 includes a lofting frame 180 having an overall rectangular shape delimited by a pair of opposed parallel side caps 182 and a pair of opposed parallel elongate frontage caps 184. The pair of side caps 182 and the pair of elongate frontage caps 184 each extend parallel to a horizontal plane PL-H delimited by the width axis WID-W and the length axis LEN-L. Each side cap 182 has a proximate end to which one end of a respective one of the elongate frontage caps 184 is fixedly attached at a perpendicular angle and a distal end to which one end of the other one of the elongate frontage caps is fixedly attached at a perpendicular angle. A planar lower façade 190 is secured to the lower surfaces of the pair of side caps 182 and the pair of elongate frontage caps 184 and the planar lower façade 190 extends parallel to the horizontal plane PL-H.

On each side cap 182 of the lofting frame 180, a pair of eyelets 874 are secured at a spacing from another with the eyelets 874 spaced from each other each to a respective side of a mid-center plane MCL that is perpendicular to the horizontal plane PL-H and parallel to the height axis HEI-H and that bisects the lofting frame 180. Eyelets 874 provide a structure for securing a wire, a cable, or another flexible member, whereupon, as is described in more detail herein, the secured wire, cable, or flexible member can be looped around or otherwise attached to a structural element, such as I-beam girder 930 (see, for example, FIG. 1) of the venue in which lofting frame 180 is deployed. Lofting frame 180 can thereby be held in a suspended disposition below the structural element of the venue via this arrangement.

Planar lower façade 190 includes a central opening 958 bisected by the mid-center plane MCL and a pair of beam guide slots 160 each on a respective side of the mid-center plane MCL. Banner 110 is raised or lowered through central opening 958.

A take-up action module 240 is configured to drivingly rotate the drum 112 around a central longitudinal axis of the drum to thereby effect winding of the banner 110 onto the drum 112 or to effect unwinding of the banner 110 from its partially or fully wound-up condition. The take-up action module 240 comprises an electric winch motor operatively couplable to an electrical power source (not shown).

A pair of light boxes 140 are each mounted to the top of the planar lower façade 190 of lofting frame 180 on a respective side of the mid-center plane MCL. Each light box 140 includes an illumination source such as, for example, a fluorescent bulb or a plurality of LEDs (light emitting diodes) or OLEDs (organic light emitting diodes), each of which emits a beam of light and the totality of light emitted by the illumination source or illumination sources of each light box 140 is designated as a light beam 510. In a configuration in which the illumination source is an elongate bulb such as, for example, an elongate fluorescent bulb, the bulb preferably extends with its elongate extent generally parallel to the length axis LEN-L whereas, in a configuration in which the illumination source comprises a plurality of bulbs each having a generally equal length and width (for example, a circular bulb), the bulbs are preferably arranged along a line parallel to the length axis LEN-L. A configuration of the bulb or bulbs generally parallel to the length axis LEN-L advantageously optimizes the volume of light that travels through the beam guide slot 160.

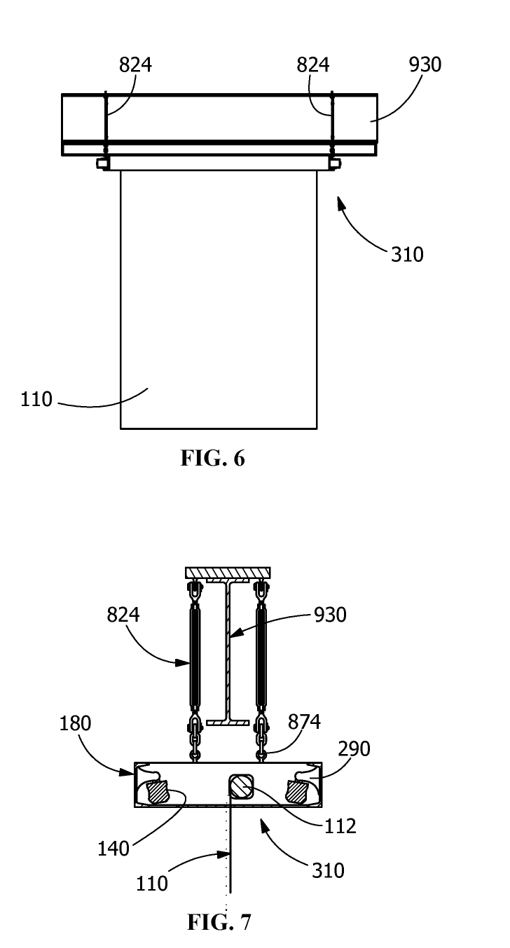

As seen in FIG. 6, which is a front plan view of the modular banner kit 310, and FIG. 7, which is a side elevation view of the modular banner kit 310, the lofting frame 180 is configured to be stably supported in a suspended disposition in which it is suspended from a suitable structural component or other component of the venue in which the modular banner kit 310 is deployed. As exemplarily shown in FIG. 6, the lofting frame 180 is stably suspended from a respective I-beam girder 930 of the stadium 922 via a steel cable suspension assembly 824. The steel cable suspension assembly 824 comprises a pair of steel cable runs each having a pair of free cable ends and each cable end is secured to a respective one of the eyelets 874 (shown in FIG. 5). A mid-portion of each steel cable run is secured, for example, to a closed loop rigging cable that encircles the I-beam girder 930 of the stadium 922.

The modular banner kit 310 comprising the banner 110 and the drum 112 is controllable in, for example, a remote manner, to effect an unwinding operation and a winding operation. In this sense, it can be understood that the modular banner kit 310 is of a type of device that, generally speaking, comprises a spindle component (e.g., a drum) particularly configured for training of a trainable surface support element therearound (e.g., a banner), wherein the term “trainable” is to be understood as a property of an element to be wound onto itself, whereupon the element is in a wound-up condition, and to be unwound from its wound-up condition to then either be in a partially unwound condition or a fully unwound condition. In this connection, it is to be understood that the term “windable” as used herein refers to a characteristic of a trainable element whereby successive portions of the trainable element are wound upon other portions of the trainable element that have already been wound onto a spindle component such that the newly wound portions substantially or fully overlie the already wound portions of the trainable element. The trainable surface support element delimits a surface that is correspondingly in a furled or wound-up condition when the trainable surface support element is in its wound-up condition and that is correspondingly partially or fully unfurled or unwound in correspondence with the respective partially unwound condition or fully unwound condition of the trainable surface support element.

The spindle component onto which the trainable surface support element is trainable is exemplarily shown as a hollow core cylindrical drum 112. The drum 112 is elongate and has a suitable surface along its longitudinal extent for securing a portion of the trainable surface support element to the drum 112 or, alternatively, for receiving the trainable surface support element laid thereon to form the innermost winding of the trainable surface support element as the trainable surface support element is trained onto the drum 112.

The banner 110, operating as a trainable surface support element, may include, for example, a natural material, a synthetic material, or a hybrid natural and synthetic material such as, for example, an extent of fabric, that delimits a surface, and the fabric extent may have a significantly reduced thickness dimension relative to its height dimension and width dimension, whereupon the fabric extent is readily trainable around the drum 112. Solely for exemplary purposes in connection with a description of the modular banner kit 310, the banner is shown as a fabric extent whereupon the fabric is operable both to operate as a carrier for graphic and/or text content and operate as a self-sufficient web that provides integrity for the banner such that it substantially maintains a planar shape when deployed, to promote movement of the banner, and/or to impart a desired texture to the banner. The banner 110 forms a surface having a base design operable to operate as a visual display for viewing by an audience present in a venue such as the stadium 922. Alternatively, or in addition, the banner 110 can form a surface onto which can be projected or otherwise transitorily displayed an image or other media feature, such as video.

The take-up action module 240 is configured to drivingly rotate the drum 112 around a central longitudinal axis of the drum 112 to thereby effect winding of the banner 110 onto the drum 112 or to effect unwinding of the banner 110 from its partially or fully wound-up condition. The take-up action module 240 includes a control box (not shown) that can be operated by a user to selectively drive the rotation of the drum 112 and, consequently, control the winding of the banner 110 onto the drum 112 or, conversely, unwinding of the banner 110 from the drum 112.

As further seen in FIGS. 4 and 5, a pair of mounting sub-assemblies 290 are each mounted to the top of the planar lower façade 190 of the lofting frame 180 on a respective side of the mid-center plane MCL and each is operatively associated with a respective one of the light boxes 140. Each one of the pair of mounting sub-assemblies 290 supports a respective one of the light boxes 140 in an orientation in which the light box 140 is generally parallel to the respective beam guide slot 160 located on the same respective side of the mid-center plane MCL. Each light box 140 has a planar lens 142 through which the light beam 510 emitted by the light box exits the light box. Each light box 140 is offset perpendicularly from the mid-center plane MCL in the direction of the width axis WID-W to a greater extent than the respective beam guide slot 160 and the extent of the offset is such that, in an orientation in which light box 140 is oriented with its planar lens 142 in parallel facing relationship to the planar lower façade 190, (a) a portion of the light beam 510 is incident upon a portion of the planar lower façade 190 that is offset perpendicularly from the mid-center plane MCL in the direction of the width axis WID-W to a greater extent than the respective beam guide slot 160 and (b) another portion of the light beam 510 passes through the respective beam guide slot 160 and forms an illuminated area 260 on banner 110.

It can be understood that varying or changing the angle delimited by the planar lens 142 of the light box 140 and the horizontal plane PL-H, in some adjustment scenarios, correspondingly increases the volume or percentage of the light beam 510 incident upon a portion of the planar lower façade 190 that is offset perpendicularly from the mid-center plane MCL in the direction of the width axis WID-W to a greater extent than the respective beam guide slot 160 while correspondingly decreasing the volume or percentage of the light beam 510 that passes through the respective beam guide slot 160 and, in other adjustment scenarios, correspondingly decreases the volume or percentage of the light beam 510 incident upon a portion of the planar lower façade 190 that is offset perpendicularly from the mid-center plane MCL in the direction of the width axis WID-W to a greater extent than the respective beam guide slot 160 while correspondingly increasing the volume or percentage of the light beam 510 that passes through the respective beam guide slot 160. A drive motor 786 may be operated remotely to bring about the desired change in the angle delimited by the planar lens 142 of the light box 140 and the horizontal plane PL-H in these adjustment scenarios.

As seen in FIGS. 4 and 5, a respective one of the pair of mounting sub-assemblies 290 is shown and the mounting sub-assembly 290 operates to fixedly mount a respective one of the light boxes 140 to the planar lower façade 190 of the lofting frame 180. The mounting sub-assembly 290 includes a pair of opposed stanchions 292 (only one of which is shown in FIG. 5) and each stanchion 292 is mounted to and extends vertically from the planar lower façade 190. A dowel 296 extends from each respective end of the light box 140, as viewed in the direction of the length axis LEN-L, and each dowel 296 is rotatably mounted in a bearing supported on a respective stanchion 292. The mounting sub-assembly 290 includes an orientation adjustment device 294 having a driven gear 782 co-axially fixedly mounted to a respective one of the dowels 296 and having a drive gear 784 rotatably mounted to a drive motor 786 housed in the respective one stanchion 292. The drive motor 786 is operatively connected to a power source (not shown) and is in communication with a remote-control device in the form, for example, of a hand-held controller or a console. An operator can operate the hand-held controller or the console to remotely control the drive motor 786 so as to effect driving rotation in a selected clockwise or counter-clockwise direction of the drive gear 784. The driven gear 782 is in meshing engagement with the drive gear 784, whereupon the driven gear 782 can be rotated via selected clockwise or counter-clockwise rotation of the drive gear 784. As the driven gear 782 is fixedly co-axially mounted to the respective dowel 296, rotation of the driven gear 782 effects rotation of the light box 140 about an axis parallel to the length axis LEN-L and thereby varies or changes the orientation of the lens via which the respective light beam 510 exits the light box 140.

The mounting sub-assembly 290 can optionally or alternatively be configured as an arrangement that does not provide a series of predetermined adjustment positions such as are provided via the orientation adjustment device 294. Instead, the mounting sub-assembly 290, as alternatively configured, can comprise a position fixing feature that can be manually moved between a position fixing position in which it secures the light box 140 against rotation and a released position in which the light box 140 can be re-oriented to a different orientation.

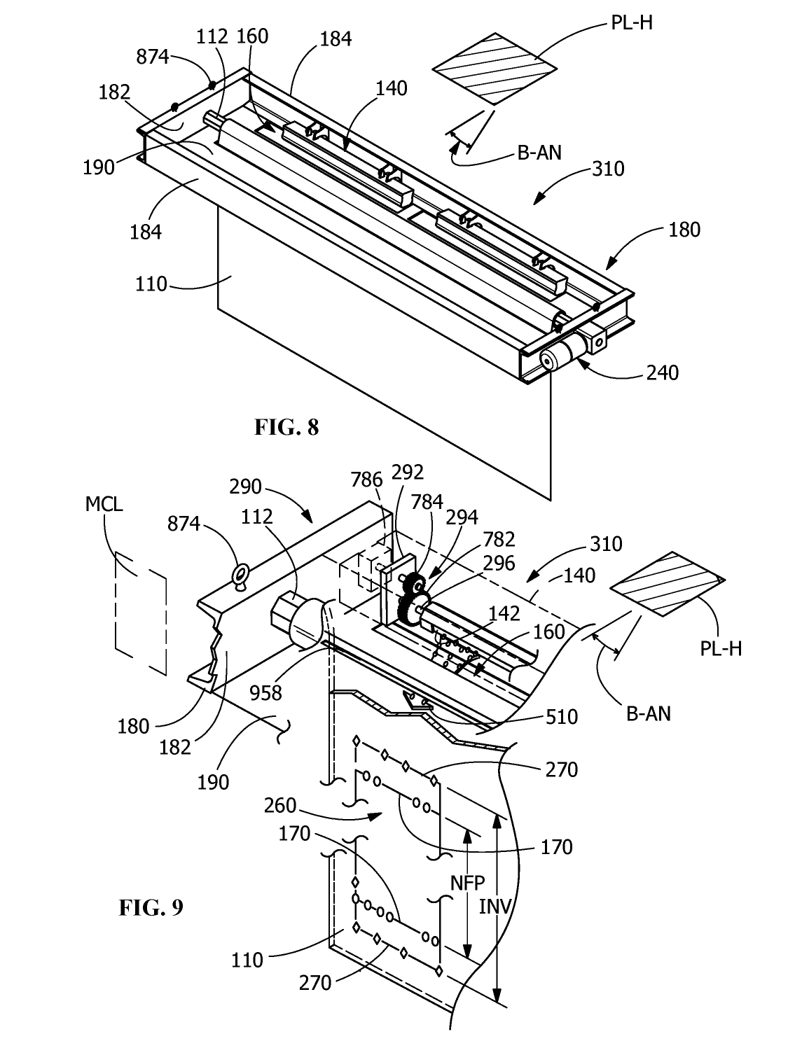

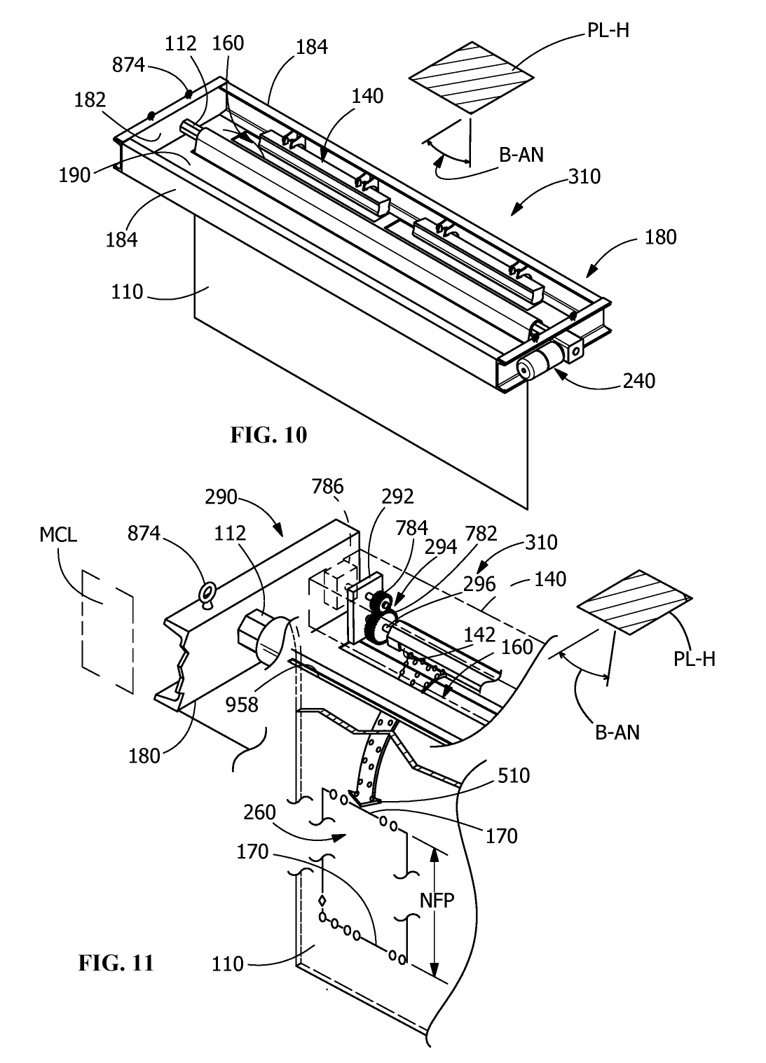

A description will now be provided to illustrate an exemplary operation of the modular banner kit 310 and reference is initially had to FIG. 8, FIG. 9, FIG. 10, and FIG. 11. Reference will be had to FIG. 8 and FIG. 9 in connection with a description of the modular banner kit 310 in which a light beam 510 is selectively activated to illuminate a nominal illuminated footprint 270 on the banner 110 and reference will be had to FIG. 10 and FIG. 11 in connection with a description of the modular banner kit 310 in which a light beam 510 is selectively activated to illuminate a greater coverage illuminated area 260 on banner 110 that has a greater area than the nominal illuminated footprint 270.

As seen in FIG. 8, the light box 140 is mounted relative to the beam guide slot 160 such that light emitted by the illumination source of the light box 140 is directed in a selected orientation relative to the beam guide slot 160. The beam guide slot 160 is in the form of a rectangular cut-out formed in the planar lower façade 190 of the lofting frame 180. The portions of the planar lower façade 190 of the lofting frame 180 that delimit the rectangular cut-out intercept some of the light emitted by the light box 140 and thereby prevent such intercepted light from traveling further outwardly of the lofting frame 180 (i.e., in a downward vertical direction parallel to the height axis HEI-H) while other portions of the light emitted by the illumination source of the light box 140 are not intercepted by the lofting frame 180 and travel through the rectangular cut-out outwardly of the lofting frame 180.

As seen in FIG. 9, which is a schematic graphical representation of the orientation of the light beam 510 emitted by the modular banner kit 310 relative to the horizontal plane PL-H delimited by the width axis WID-W and the length axis LEN-L, when the light beam 510 extends from the light box 140 and through the beam guide slot 160, and the light beam 510 is incident upon, or intercepted by, the banner 110, with the light beam 510 and the horizontal plane PL-H together delimiting a beam incidence angle B-AN. The beam incidence angle B-AN may have a value from and between one (1) degree and ninety (90) degrees. In the exemplary configuration shown in FIG. 8, the beam incidence angle B-AN has a value of thirty-five (35) degrees. As a consequence of the beam incidence angle B-AN having a value of thirty-five (35) degrees, the fall of light of the light beam 510 illuminates a nominal illuminated footprint 170 (shown in a dash-diamond line) on the banner 110. The fall of light of the light beam 510 is considered to illuminate any given portion of the banner 110 if such given portion of the banner 110 is more visible to a given audience member during a time that the light beam 510 is present as compared to another time during which the light beam 510 is not present. This portion of the banner 110 whose visibility has been enhanced in this manner is characterized as an “illuminated footprint.”

As seen in FIG. 10, the light box 140 is mounted relative to the beam guide slot 160 such that light emitted by the illumination source of the light box 140 in the form of the light beam 510 is directed in a selected orientation relative to the beam guide slot 160 to form illuminated area 260. As seen in FIG. 11, which is a schematic graphical representation of the orientation of the light beam 510 relative to a horizontal plane PL-H delimited by the width axis WID-W and the length axis LEN-L, when the light beam 510 projects from the light box 140, through the beam guide slot 160, and is intercepted by the banner 110, the light beam 510 and the horizontal plane PL-H together delimit a beam incidence angle B-AN. The beam incidence angle B-AN has a value of seventy (70) degrees. As a consequence of the beam incidence angle B-AN having a value (seventy (70) degrees) that is greater than the beam incidence angle B-AN (thirty-five (35) degrees) described in connection with the description of the nominal illuminated footprint 170 on the banner 110 illustrated in FIG. 8 and FIG. 9, the fall of light of the light beam 510 illuminates a greater coverage illuminated footprint 270 (shown in a dash-double circle line) on the banner 110. The greater coverage illuminated footprint 270 (shown in a dash-double circle line) and the nominal illuminated footprint 170 (shown in a dash-diamond line) have the same co-extensive lateral extents (as viewed in the direction of the axis LEN-L) on the banner 110. The nominal illuminated footprint 170 has a lesser height extent NFP (as viewed in the direction of the height axis HEI-H) than the greater coverage illuminated footprint 270, which has an overall height extent INV, as viewed in the direction of the height axis HEI-H.

Thus, the overall height length of the greater coverage illuminated footprint 270 on the banner 110 can be adjusted to or set at a predetermined value via a step of selectively setting or adjusting the orientation of the light box 140 and the beam guide slot 160 to one another, whereupon this action of adjusting the orientation will correspondingly result in an adjustment of the beam incidence angle B-AN to a predetermined value that is relatively low (i.e., closer to the lower range value of one (1) degree than to the upper range value of ninety (90) degrees) or relatively high (i.e., closer to the upper range value of ninety (90) degrees than to the lower range value of one (1) degree). The beam incidence angle B-AN can be varied via a step of setting the orientation of the light box 140 relative to the beam guide slot 160 at a new or different value than the previously specified value of the beam incidence angle B-AN. For example, in accordance with an aspect of the method of the present invention, the beam incidence angle B-AN can be varied from a previously specified value of thirty-five (35) degrees—that is, the value of the beam incidence angle B-AN that has been described and illustrated with respect to FIG. 8 and FIG. 9—to a new or different predetermined value of twenty-two (22) degrees. This is accordingly an example of adjusting or varying the beam incidence angle B-AN from a relatively higher value to a relatively lower value. In the event that the light box 140 is mounted relative to the beam guide slot 160 of the lofting frame 180, as has been described with respect to FIG. 8 and FIG. 9, adjusting or varying the beam incidence angle B-AN from a relatively higher value to a relatively lower value will result in a relatively greater percentage of the light beam 510 being intercepted by the planar lower façade 190 of the lofting frame 180.

The present invention also provides a method of deploying a banner. The method includes a step of providing a modular banner kit having a banner, a spindle component configured for training of the banner therearound, a take-up action element configured to drivingly rotate the spindle component to thereby effect winding of the banner onto the spindle component or to effect unwinding of the banner from a partially or fully wound-up condition, and an illumination element operable to emit illumination at least a portion of which is incident upon the banner and the spindle component. The method further includes a step of operating the take-up action element to drivingly rotate the spindle component so as to thereby drivingly raise or lower the banner. The method additionally includes a step of operating the illumination element to emit illumination.

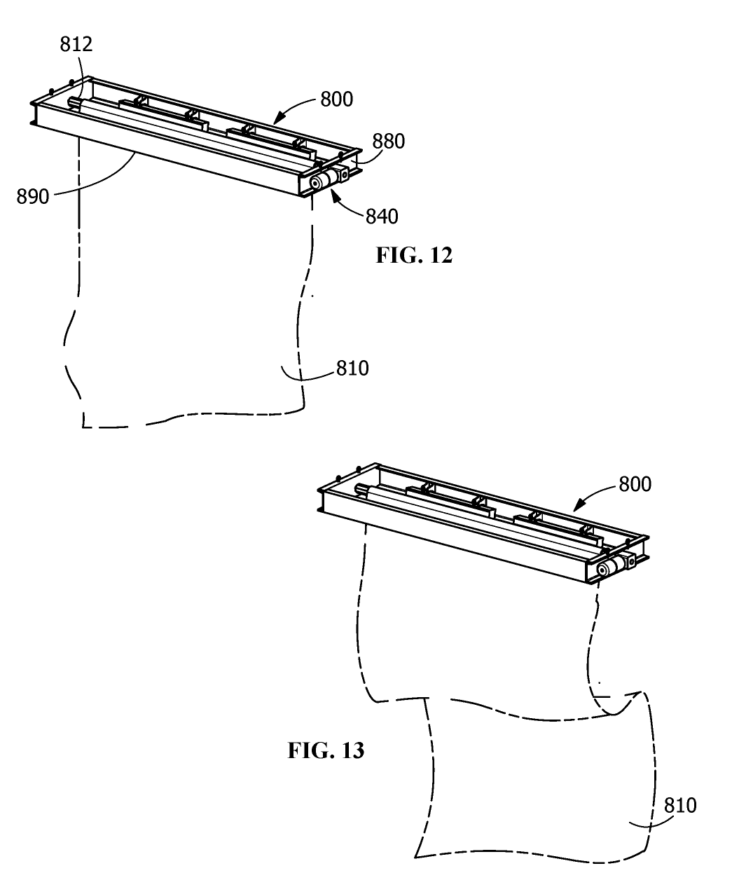

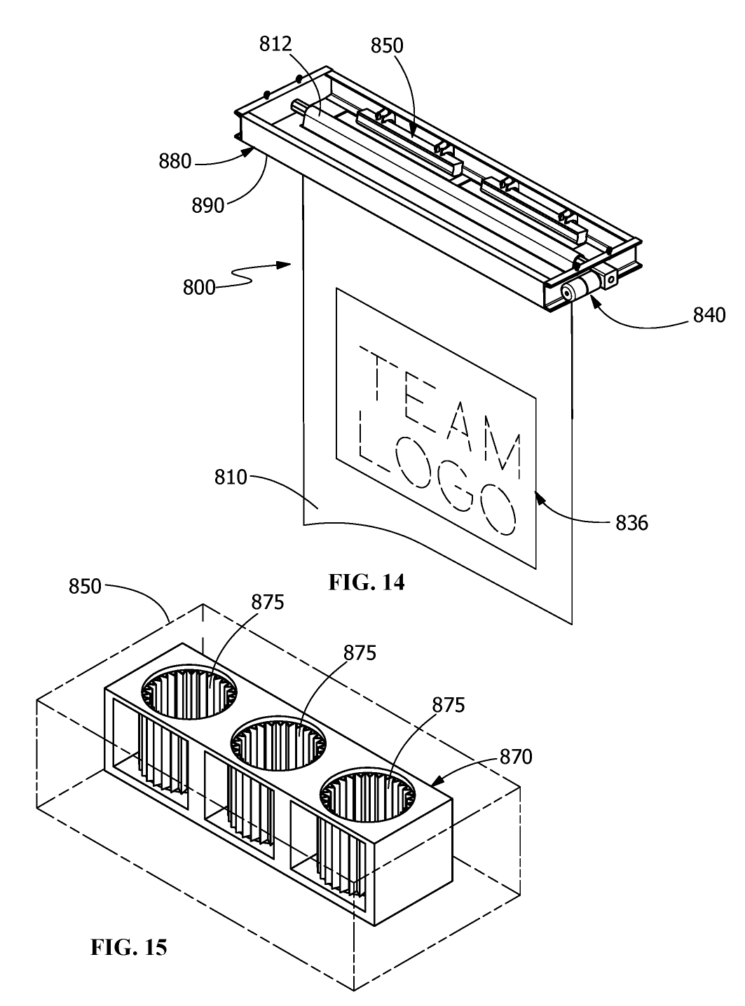

Reference is now had to FIG. 12, FIG. 13, and FIG. 14 in connection with a description of one variation of the modular banner kit of the present invention. FIG. 12 is a top perspective view of the one variation of the modular banner kit and shows a modular banner kit 800 having a banner 810 identically configured to the banner 110, a drum 812 identically configured to the drum 112, a lofting frame 880 identically configured to the lofting frame 180, a take-up action module 840 identically configured to the take-up action module 240, and a planar lower façade 890 identically configured to the planar lower façade 190. The banner 810 is windable onto the drum 812 and unwindable from the drum 812 to a fully unwound condition in which the banner 810 may operate in a customary or conventional role as a banner having graphic or text content visible thereon. Additionally, the banner 810 may be subjected to a motive influence, such as a breeze or a stream of air or fluid purposefully directed to contact the banner 810, as a consequence of which the banner 810 moves, undulates, or flutters. The modular banner kit 800 is operable in accordance with the method of the present invention to advantageously deploy the banner 810 in its fully unwound condition or in a partially unwound condition such that: (a) graphic or text content on the banner can be viewed by audience members, (b) the banner flutters, undulates, or otherwise moves, or (c) the banner both displays graphic or text content and flutters, undulates, or otherwise moves. FIG. 12, which is a top perspective view of the one variation of the modular banner kit 800, shows the banner 810 undergoing a flutter movement.

As seen in FIG. 14, which is a top perspective view of the one variation of the modular banner kit 800 shown in FIG. 10 and FIG. 11, the modular banner kit 800 includes a light box 850 that comprises an illumination source such as, for example, a fluorescent bulb or a plurality of LEDs (light emitting diodes) or OLEDs (organic light emitting diodes), each of which emits a beam of light. The light box 850 extends co-extensive with the cut-out opening in the planar lower façade 890 along one-half of the longitudinal extent of the cut-out opening in the planar lower façade 890. As seen in FIG. 15, which is an enlarged top perspective view of a portion of the one variation of the modular banner kit 800 shown in FIG. 14, the modular banner kit 800 includes a motive air module 870 that extends co-extensive with the cut-out opening in the planar lower façade 890 along the other respective half of the longitudinal extent of the cut-out opening in the planar lower façade 890. The motive air module 870 is operatively connected to an electrical source (not shown) and includes a plurality of fan motors each operable to selectively rotate a fan 875 fixedly mounted to an output shaft of the fan motor. The motive air module 870 is operable to selectively propel motive air streams through the cut-out opening in the planar lower façade 890 and into contact with the banner 810 to thereby cause the banner 810 to flutter or undulate in a wave-like movement pattern in response to the impact thereon of the motive air streams.

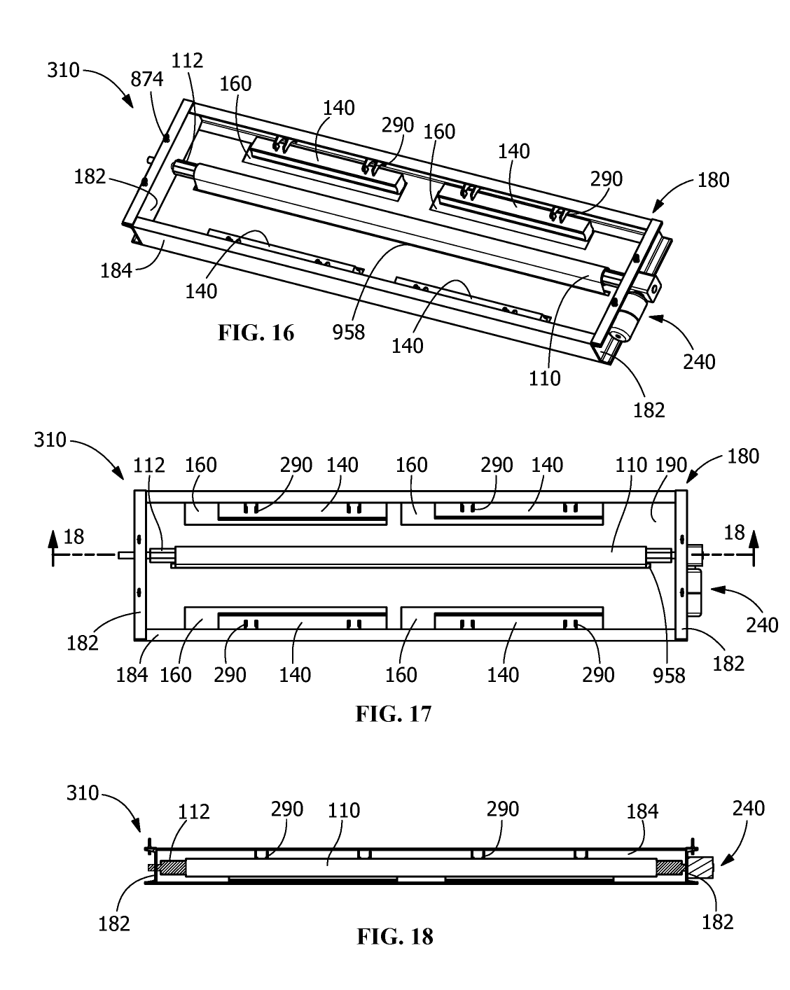

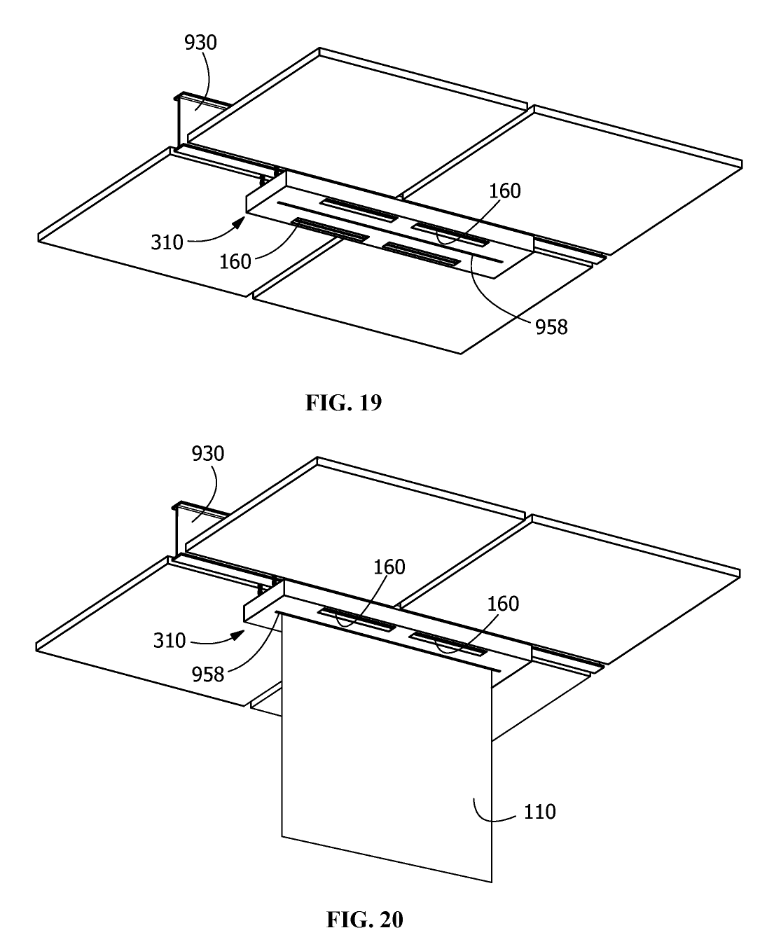

FIGS. 16, 17, and 18 show various detailed views of an embodiment of the modular banner kit 310. The arrangement of the components modular banner kit 310 are substantially identical to that described to the modular banner kit described with respect to FIG. 4.

FIGS. 19, 20 and 21 show implementations of modular banner kit 310 according to embodiments of the present invention in an installation, such as in an entertainment venue or stadium 922. FIGS. 19 and 20 show a modular banner kit 310 suspended from an I-beam girder 930. FIG. 19 shows the banner 110 in a retracted or stored position. FIG. 20 shows the banner 110 in a deployed position. As is visible in each of FIGS. 19 and 20, the modular banner kit 310 includes beam guide slots 160, which permit light from the light box 140 (not shown in FIGS. 19 and 20), to illuminate banner 110. Likewise, beam guide slots 160 would permit passage of air or similar fluid to interact with banner 110 in the deployed position and provide fluttering or undulating. The position shown in FIG. 19 is a position suitable for use when the modular banner kit 310 is to be removed or moved. In addition, the stored position shown in FIG. 19 is also suitable for when the entertainment venue is hosting a traveling show, such as a concert or theatrical presentation, or is hosting an entertainment event which does not related to the subject matter of the banner 110. The stored position provides additional space in the venue and also provides additional space and access to the roof structural elements or I-beam girders 930 for suspending traveling show components, such as supports or trusses for automation, lighting and/or sound.

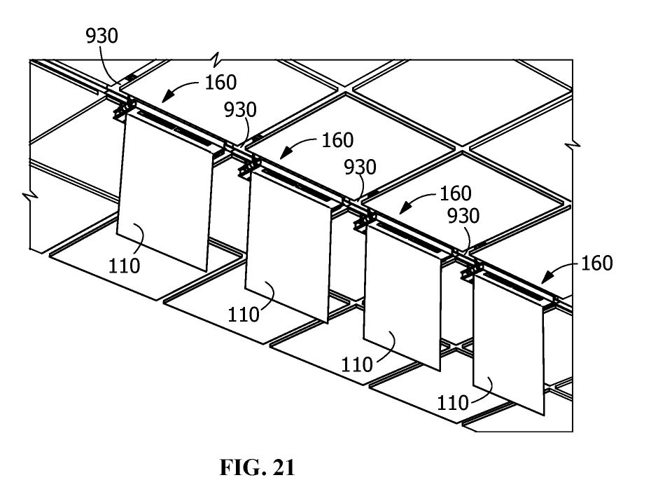

FIG. 21 shows a plurality of modular banner kits 310 arranged along and suspended from an I-beam girder 930 in a substantially identical arrangement shown and described with respect to FIGS. 19 and 20. As shown in FIG. 21, the modular banner kits 310 have banners 110 in the deployed position. The modular banner kits 310 can be independent of one another or can have their drive systems and illumination networked to one another in a manner that permits coordinated illumination and/or retraction/deploying of banner 110. For example, each of modular banner kits 310 can include a network address or node that provides control of the movement and/or illumination of banner 110. In such an embodiment, the retraction and deploying of the banners 110 may be coordinated to provide customized positioning of banners 110 and/or provide a specific visual effect with the banners 110.

It is important to note that the construction and arrangement of the modular banner kit and the method, as shown in the exemplary embodiment and the variations described herein, are illustrative only. Although only a single exemplary embodiment has been described in detail in this disclosure, those who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

The present application contemplates the deployment of any suitable methods, systems, or program products on any machine-readable media that may assist in the design, configuration, manufacture, or operation of the apparatus and methods of the present invention. The embodiments of the present application may be implemented using an existing computer processor, or by a special purpose computer processor for an appropriate system, incorporated for this or another purpose or by a hardwired system.

As noted above, embodiments within the scope of the present application include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM, or other optical disk storage, magnetic disk storage, or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general-purpose computer, special-purpose computer, or special-purpose processing machines to perform a certain function or group of functions.

It should be noted that although the figures herein may show a specific order of method steps, it is understood that the order of these steps may differ from what is depicted. Also, two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule-based logic and other logic to accomplish the various connection steps, processing steps, comparison steps and decision steps.

The present application is not limited to a particular embodiment, but extends to various modifications that nevertheless fall within the scope of the appended claims. The order or sequence of any processes or method steps may be varied or re-sequenced according to alternative embodiments.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A modular banner kit comprising:
a trainable surface support element;
a spindle component configured for training of the trainable surface support element therearound;
a targeted illumination feature operable to selectively increase the visibility of the trainable surface support element; and
a take-up action module configured to drivingly rotate the spindle component to thereby effect winding of the trainable surface support element onto the spindle component or to effect unwinding of the trainable surface support element from a partially or fully wound-up condition.

2. The modular banner kit according to claim 1, wherein the trainable surface support element is a banner.

3. The modular banner kit according to claim 2, wherein the targeted illumination feature includes a cut-out opening through which a light beam passes to illuminate the banner.

4. The modular banner kit according to claim 1, wherein the banner includes a pennant, a jersey, a team or player identifier, an award, an advertisement, or combination thereof.

5. The modular banner kit according to claim 1, wherein the spindle is housed in a lofting frame having an overall rectangular shape delimited by a pair of opposed parallel side caps and a pair of opposed parallel elongate frontage caps and a lower planar façade.

6. The modular banner kit according to claim 5, wherein the lofting frame includes at least two eyelets to attach to a wire, a cable, or another flexible member.

7. The modular banner kit according to claim 5, wherein the lower planar façade includes beam guide slots arranged and disposed to permit light from the targeted illumination feature to illuminate the trainable surface support element.

8. The modular banner kit according to claim 1, wherein the targeted illumination feature includes a moveable planar lens configurable to various angles to form an illuminated area.

9. The modular banner kit according to claim 1, further comprising a motive air module operable to selectively propel motive air streams into contact with the trainable surface support element to thereby cause the trainable surface support element to flutter or undulate in a wave-like movement pattern in response to the impact thereon of the motive air streams.

10. A method of deploying a banner, the method comprising:
providing a modular banner kit having a banner, a spindle component configured for training of the banner therearound, a take-up action element configured to drivingly rotate the spindle component to thereby effect winding of the banner onto the spindle component or to effect unwinding of the banner from a partially or fully wound-up condition, and an illumination element operable to emit illumination at least a portion of which is incident upon the banner and the spindle component; and
operating the take-up action element to drivingly rotate the spindle component so as to thereby drivingly raise or lower the banner; and
operating the illumination element to emit illumination.

11. The method of claim 10, wherein the method includes raising the banner to a stored position, forming a space in an entertainment venue to accommodate a portable stage or hard surface floor.

12. The method of claim 11, wherein the stored position provides access to the roof structural elements or I-beam girders for suspending traveling show components.

13. The method of claim 10, wherein the modular banner kit is operated remotely by a hand-held controller or console.

14. The method of claim 10, wherein the illumination element is configured to provide an illumination area of a preselected size.

15. The method of claim 10, wherein the illumination element is actively configured to change the size of an illumination area.

16. The method of claim 10, further comprises providing a motive air module within the modular banner kit and activating the motive air module to move the banner in a fluttering or undulating motion.

17. An entertainment venue comprising:
a roof structural component;
a plurality of modular banner kits suspended by the roof structural component, each modular banner kit comprising:
a trainable surface support element;
a spindle component configured for training of the trainable surface support element therearound;
a targeted illumination feature operable to selectively increase the visibility of the trainable surface support element; and
a take-up action module configured to drivingly rotate the spindle component to thereby effect winding of the trainable surface support element onto the spindle component or to effect unwinding of the trainable surface support element from a partially or fully wound-up condition.

18. The entertainment venue of claim 17, wherein the spindle is housed in a lofting frame having an overall rectangular shape delimited by a pair of opposed parallel side caps and a pair of opposed parallel elongate frontage caps and a lower planar façade.

19. The entertainment venue of claim 18, wherein the lofting frame includes at least two eyelets attached a closed loop rigging cable that encircles the roof structural component.

20. The entertainment venue of claim 17, wherein the plurality of modular banner kits is networked and capable of selective deployment and retraction of each individual modular banner kit.
